(19) United States
(12) Patent Application Publication
(10) Pub. No.: US 2023/0316215 A1
(43) Pub. Date: Oct. 5, 2023

(54) INCENTIVE-BASED REROUTING OF ITEM DELIVERY

(71) Applicant: INTERNATIONAL BUSINESS MACHINES CORPORATION, Armonk, NY (US)

(72) Inventors: Shikhar Kwatra, San Jose, CA (US); Tiberiu Suto, Franklin, NY (US); Jeremy R. Fox, Georgetown, TX (US); Venkata Vara Prasad Karri, Visakhapatnam (IN)

(21) Appl. No.: 17/700,843

(22) Filed: Mar. 22, 2022

(51) Int. Cl. G06Q 10/08; G06Q 30/02

(52) U.S. Cl. CPC G06Q 10/0832; G06Q 30/0208

(57) ABSTRACT

A delivery location of a first user is linked to a tokenized identifier of a package including an ordered item and delivery is initiated. A second order for the same item is received from a second user also requesting expedited delivery while the item ordered by the first user is en-route for delivery. An incentive is offered to a computing device of the first user in exchange for agreeing to a delayed delivery of the item ordered by the first user. An expedited delivery timeframe in exchange for additional compensation is offered to a computing device of the second user, and in response to receiving an acceptance of the incentive for delayed delivery and the expedited delivery in exchange for additional compensation the link to the tokenized identifier is changed to a delivery location of the second user while the package including the item is en-route.

### BACKGROUND

The present invention relates to shipping delivery of ordered items, and more specifically, to incentive-based re-routing of delivery for ordered items.

Participation and frequency of online orders have been increasing rapidly over time. Online orders depend on delivery by a transportation provider and include the issues associated with the logistics of delivery and user expectations of delivery time. Often, a delay in shipping deliveries occurs due to order volume, delivery distance, and other factors. Some delivery providers offered guaranteed delivery time for subscribed members, however, instances of high-volume orders have reduced the guarantee to an objective that is often not met.

In many instances, user orders are processed and shipped consistently with the order in which they were received. Users with urgent needs for delivery of an item are constrained by the lead time of the item provider and shipping times available from the delivery provider.

### SUMMARY

A computer-implemented process for dynamic delivery re-allocation of an en-route item. The method provides for one or more processors to receive an online order for an item from a first user. The one or more processors link a first delivery location of the first user to a tokenized identifier attached to a package including the item and initiating delivery of the item to the first delivery location of the first user. The one or more processors receive a second order for the item from a second user while the item ordered by the first user is en-route for delivery to the first user, wherein the second user requests expedited delivery of the item. The one or more processors offer a first incentive to a first computing device of the first user, wherein the first incentive is in exchange for delayed delivery of the item ordered by the first user. The one or more processors offer an expedited delivery timeframe in exchange for additional compensation to a second computing device of the second user, and in response to receiving an acceptance of the incentive from the first computing device and an acceptance of the expedited delivery in exchange for additional compensation from the second computing device, the one or more processors change the link to the tokenized identifier to a second delivery location of the second user while the package including the item is en-route.

### BRIEF DESCRIPTION OF THE DRAWINGS

FIG. 1 is a functional block diagram illustrating a distributed computer processing environment, in accordance with an embodiment of the present invention.

FIG. 2 depicts a flowchart of the operational steps of an expedite delivery program, in accordance with an embodiment of the present invention.

FIG. 3 depicts a block diagram of components of a computing system, including a computing device configured to operationally perform the expedite delivery program of FIG. 2, in accordance with an embodiment of the present invention.

### DETAILED DESCRIPTION

Embodiments of the present invention recognize online ordering and purchase of deliverable items has increased significantly, placing increased demands on delivery of ordered items as well as demand for shorter delivery time requirements. Embodiments recognize that some users that order an item online are interested or require expedited delivery of the ordered item and are willing to compensate for receiving the expedited delivery, whereas other users are indifferent regarding delay of the delivery of an ordered item for a reasonable time.

Embodiments of the present invention recognize that expedited delivery has limits based on the delivery location, the logistics of delivery methods, the number, and types of hand-offs to make the delivery of the ordered item. Embodiments recognize that in some cases a need or desire may exist for expedited delivery of an item that cannot be met due to the limits of current expedited delivery, such as “overnight” or “next day” delivery.

Embodiments of the present invention provide more options of order delivery based on reallocating an item already en-route to a first delivery location, to a second delivery location of a user requesting the expedited delivery (“en-route” refers to a status in which the item or package to be delivered has departed from a starting point, such as a provider of the item, and is being transported to a delivery destination, but has not yet arrived at the destination). Embodiments determine the reallocation of the ordered item by a delivery negotiation utilizing a first user’s device. Embodiments initially intend the first user as the recipient of the ordered item en-route, and a second user’s device, whose user requested the expedited delivery of the item. Embodiments include an offer of an incentive to the first user who ordered the item already en-route, in exchange for a delay in receiving the ordered item. Embodiments include an incentive to the order-receiving entity (referred to herein as a/the vendor) in the form of additional compensation from the second user in exchange for the expedited delivery. Embodiments of the present invention negotiate the incentives and receive an acceptance or decline from the first and second users via the respective user devices.

In some embodiments, configuration of the respective user’s devices, also referred to as user’s edge devices, include a programmable application to perform a learning function regarding the user’s behaviors relative to negotiations of a delivery delay of ordered items. In some embodiments, the user manually receives incentive notification for delay of an ordered item already en-route so that the ordered item may be reallocated to a second user requesting and accepting additional compensation requirements for expedited delivery. The application operating on the user’s device uses machine learning techniques using the user’s history of negotiation of incentive for the delivery delay to determine the user’s behavior, strategies, and decision making. Similarly, the application operating on a second user’s device uses machine learning techniques to determine the user’s behavior, strategies, and decision-making for accepting additional compensation requirements provided to the vendor of the ordered item to receive expedited delivery of an ordered item already en-route.

In some embodiments, the user device applications receive direct training by supervised learning performed by respective users, and unsupervised training based on user-based historic decisions made, incentives offered, or compensation required, and attributes of items ordered. Training of respective user device applications enables decision-making by virtual personas of the respective users without the need for the users to actively engage in the delivery negotiations. Because of a limit to the window of expedited delivery of an item already en-route to a destination, the use of a virtual persona to receive an incentive or a requirement for additional compensation enables an immediate consideration and response avoiding delays in human response to the incentive offers and compensation requirements. In some embodiments, users can manually set overriding parameters for the virtual personas which may accept or decline any incentive or required compensation based on the ordered item or other configurable conditions.

Embodiments of the present invention include multiple considerations associated with the rerouting of en-route delivery of an online ordered item. An offer of an incentive for delay of an ordered item to a first user considers the type and magnitude of an incentive most likely to be accepted by the first user without excessive offering. Additionally, embodiments consider the history of the first user agreeing to delays of delivery, the current demand and supply of the ordered item, and the number of other users with an ordered instance of the item en-route. Similarly, embodiments estimate or determine the type and magnitude of the incentive offer, the additional costs of rerouting and delivering the item to the second user’s location, and the desired profit of the vendor performing the rerouting and reordering in determining the options and the corresponding required compensation directed to the second user requesting expedited delivery of the item.

In some embodiments, an application receiving requests for expedited delivery of a first item and tracking current en-route deliveries of the first item communicatively connects to a vendor receiving orders for the first item and managing the delivery of the ordered items. Embodiments include a tokenized identifier on the packaging of the ordered item that enables changing the delivery location address associated by link to the package during en-route delivery. The tokenized identifier is scanned or read linking to data providing the delivery address. In some embodiments, an alert indicates a delivery address change and prompts scanning or reading of the tokenized identifier so that delivery travel can be adjusted.

In some embodiments, the vendor may adjust the initial delivery timeframe facilitating the opportunity of receiving requests for expedited delivery, such as designated time in distribution facilities near large populations

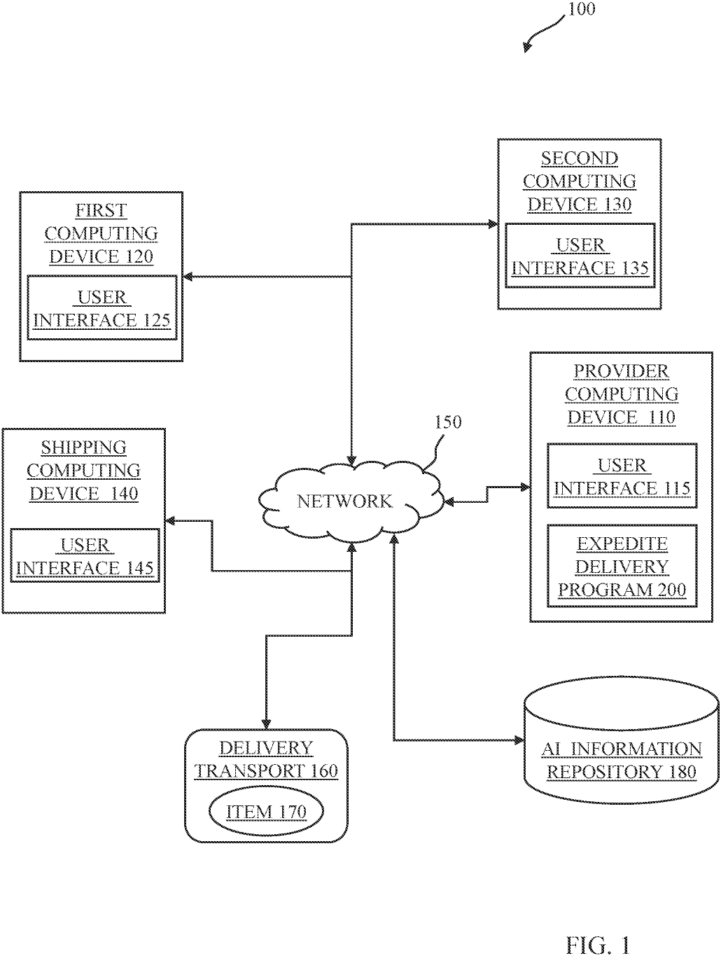

The present invention will now be described in detail with reference to the Figures. FIG. 1 illustrates a functional block diagram of a distributed computer processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

FIG. 1 illustrates a functional block diagram of a distributed computer processing environment, in accordance with an embodiment of the present invention. FIG. 1 includes a first computing device 110, second computing device 120, shipping computing device 130, provider computing device 140, delivery transport 160, item 170, AI information repository 180, all connected through network 150.

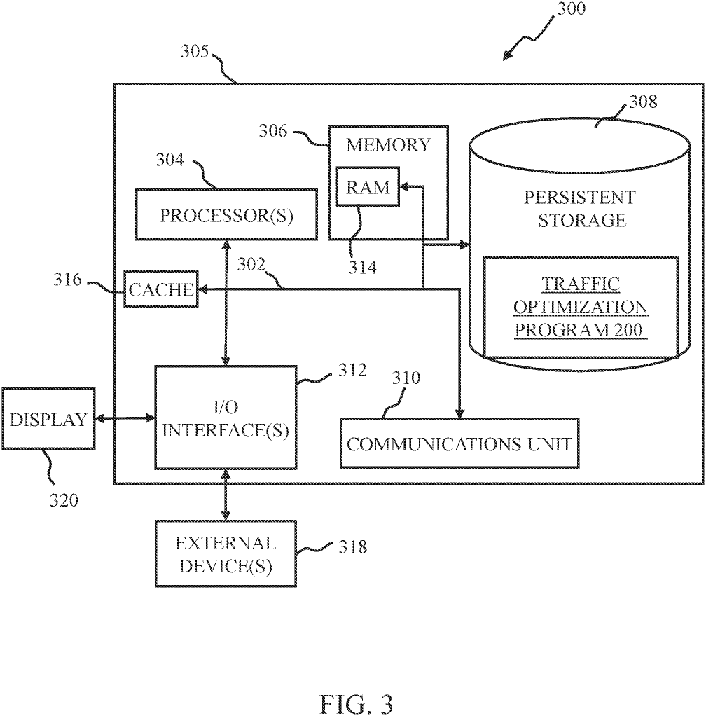

Provider computing device 110, first computing device 120, second computing device 130, and shipping computing device 140 include user interfaces 115, 125, 135, and 145, respectively. Provider computing device 110 also includes expedite delivery program 200. In some embodiments, provider computing device 110, first computing device 120, second computing device 130, and shipping computing device 140 can be a laptop computer, a desktop computer, a mobile computing device, a smartphone, a tablet computer, or other programmable electronic device or computing system capable of receiving, sending, and processing data. In other embodiments, provider computing device 110, first computing device 120, second computing device 130, and shipping computing device 140 may be a stand-alone computing device interacting with applications and services hosted and operating in a cloud computing environment. In still other embodiments, one or more of provider computing device 110, first computing device 120, second computing device 130, and shipping computing device 140 may be a wearable item or be included in a wearable item of a user. In yet other embodiments, provider computing device 110, first computing device 120, second computing device 130, and shipping computing device 140 can be a netbook computer, a personal digital assistant (PDA), or other programmable electronic devices capable of receiving data from and communicating with provider computing device 110. Provider computing device 110, first computing device 120, second computing device 130, and shipping computing device 140 may include internal and external hardware components, depicted in more detail in FIG. 3.

In some embodiments, first computing device 120 operates as an edge device by a first user and receives an incentive offer for agreeing to accept a delay of the delivery of an ordered item. In some embodiments, first computing device 120 includes functions to track the behavioral activity and decisions of the first user, who opts-in agreeing with the tracking, in regard to the receipt of incentive offers for a delivery delay agreement. In some embodiments first computing device 120 applies machine learning and artificial intelligence (AI) techniques to enable a virtual persona capability to assess incentive offers for ordered item delivery delay and perform decisions on behalf of the first user, without the first user’s intervention. In some embodiments, the first user provides supervised learning input and sets limitations for the virtual persona operation of first computing device 120.

In some embodiments, second computing device 130 operates as an edge device by a second user and interacts with provider computing device 110 to place an order for the same item ordered by first computing device 120 and requests expedited delivery. Second computing device 130 receives a response from expedite delivery program 200 operating on provider computing device 110 indicating required compensation for the expedited delivery of the ordered item (if embodiments determine the availability of expedited delivery). In some embodiments, options for expedited delivery are offered to second computing device 130, which may correspond to multiple instances of the ordered item already en-route and at different stages and distances from the location of the second user operating second computing device 130. In some embodiments, each option may provide a delivery time associated with a corresponding compensation due to the provider.

For example, three instances of the ordered item already en-route to original ordering users may exist. All three instances have indicated agreement to accept delayed delivery. Expedite delivery program 200 operating on provider computing device 110 sends the estimated delivery time and corresponding compensation associated with each of the three instances to second computing device 130 for a decision. The options may include delivery in two hours for a high amount of compensation; delivery in 12 hours for a medium compensation; and delivery the next day for low compensation.

In some embodiments, second computing device 120 includes functions to track the behavioral activity and decisions of the second user, who opts-in agreeing with the tracking, in regard to the selection of expedited delivery and agreed to compensation. In some embodiments, second computing device 130 applies machine learning and artificial intelligence (AI) techniques to enable a virtual persona capability to assess the delivery time and required compensation offers for expedited delivery of ordered items and perform decisions on behalf of the second user, without the second user’s intervention. In some embodiments, the second user provides supervised learning input and sets limitations for the virtual persona operation of second computing device 130.

The use of AI and training based on historic user acceptance and decline actions, to support a virtual persona acting on behalf of respective users includes feedback from users subsequent to decisions by virtual personas provides a means of assessment and improvement for decisions regarding incentives and compensations from a user perspective, and the respective user historic data interacting with expedite delivery program 200 enables improvement of incentive offers and additional compensation requirements to achieve higher levels of user agreements and increase benefit to item providers. The historic data may also include demand of items, delivery location areas, and timing of orders (i.e., close to holidays, graduations, etc.).

Shipping computing device 140 includes user interface 145 and receives shipping information from expedite delivery program 200 operating on provider computing device 110, via network 150. Shipping computing device 140 serves a shipping vendor that receives instruction from expedite delivery program 200 for online orders received and for instances of rerouting of delivery to an alternate delivery location for expedited delivery. Shipping computing device 140 provides delivery data and information to delivery transport 160. In some embodiments, shipping computing device 140 provides the delivery name and address information for items to be delivered by a link from a tokenized identifier on packages of items included for delivery, by delivery transport 160. The use of the tokenized identifier on respective packages included in delivery transport 160 enables the delivery location and name associated with the respective package (i.e., ordered item) to be adjusted for rerouting to a different user at a different location during en-route delivery of the package. For example, a scannable label on the packaging of an item included in delivery transport 160 may link to delivery information maintained by shipping computing device 140, which receives input of delivery information from expedite delivery program 200 operating on provider computing device 110. Expedite delivery program 200 may initiate rerouting of an ordered item already en-route by sending the change of delivery information to shipping computing device 140, which makes the change of destination to the link associated with the tokenized identifier of the packaging for the ordered item. In some embodiments, the rerouting of destination includes immediately updating delivery destination information available to delivery transport 160.

Provider computing device 110 receives online orders for items to be delivered to requesting users. In some embodiments, provider computing device 110 communicates with first computing device 120 and second computing device 130 receiving requests for expedited delivery of an ordered item and sending incentive offers, and delivery and compensation options to first computing device 120 and second computing device 130, respectively. In response to an agreement of delayed delivery by first computing device 120 and submission of compensation for an expedited delivery option by second computing device 130, provider computing device 110 initiates rerouting communication between expedite delivery program 200 and shipping computing device 140.

In some embodiments of the present invention, provider computing device 110 can be a blade server, a web server, a laptop computer, a desktop computer, a standalone mobile computing device, a smartphone, a tablet computer, or another electronic device or computing system capable of receiving, sending, and processing data. In other embodiments, computing device 110 may be a computing device interacting with applications and services hosted and operating in a cloud computing environment. In another embodiment, the computing device 110 can be a netbook computer, a personal digital assistant (PDA), or other programmable electronic devices capable of receiving data from and communicating with provider computing device 110 includes the capability to communicate with other devices of distributed computer processing environment 100 (not shown), via network 150, as well as hosting the expedite delivery program 200. Alternatively, in some embodiments, provider computing device 110 may be communicatively connected to expedite delivery program 200, operating remotely. Provider computing device 110 may include internal and external hardware components, depicted in more detail in FIG. 3.

User interfaces 115, 125, 135, and 145, provide interfaces to access the features and functions of provider computing device 110, first computing device 120, second computing device 130, and shipping computing device 140, respectively. In some embodiments of the present invention, user interfaces 125, 135, and 145 provide access to receive data and information from provider computing device 110 and to send data and information to expedite delivery program 200 operating on provider computing device 110. User Interface 115 may also provide a display of output for functions and applications of respective computing devices. computing device 110 to access additional features and functions of computing device 110 (not shown).

User interfaces 115, 125, 135, and 145 support access to alerts, notifications, and provide access to forms of communications. In one embodiment, user interfaces 115, 125, 135, and 145 may be a graphical user interface (GUI) or web user interface (WUI) and can receive user input and display text, documents, web browser windows, user options, application interfaces, and instructions for operation, and include the information (such as graphic, text, and sound) that a program presents to a user and the control sequences the user employs to control the program. In another embodiment, user interfaces 115, 125, 135, and 145 may also include mobile application software that provides respective interfaces to features and functions of provider computing device 110, first computing device 120, second computing device 130, and shipping computing device 140. User interface 115 enables respective users of provider computing device 110 to receive input, display, and respond to input from first computing device 120, second computing device 130, and shipping computing device 140.

Network 150 can be, for example, a local area network (LAN), a wide area network (WAN), such as the Internet, a virtual local area network (VLAN), or any combination that can include wired, wireless, or optical connections. In general, network 150 can be any combination of connections and protocols that will support communication and data transmission between provider computing device 110, first computing device 120, second computing device 130, shipping computing device 140, delivery transport 160, and artificial intelligence information repository 180, and other devices and elements of distributed computer processing environment 100 (not shown).

Delivery transport 160 represents the transportation devices used to receive the ordered item (item 170) and transport the item to a final delivery destination. In some embodiments, delivery transport 160 may be a ground delivery vehicle, whereas, in other embodiments, delivery transport 160 may be an autonomous delivery device or an airborne delivery drone. In some embodiments, delivery transport 160 may include combinations of vehicles, devices, and users contributing to the delivery of the ordered item from the provider to the final delivery destination. In some embodiments, delivery transport 160 detects changes to a tokenized identifier associated with a package for delivery in which the reading of the tokenized identifier attached or associated with a package, when scanned or read by wireless devices links to a delivery location address and may include a delivery recipient name. For example, the tokenized identifier may be a QR code corresponding to a link to a delivery location address of a first user, stored in a file on shipping computing device 140. Embodiments reallocate item 170 to a second user by changing the delivery location address in the link corresponding to item 170′s package QR code to that of the second user. The change of delivery location address reroutes item 170 from a first user to a second user.

A first user performs an online order of item 170 using first computing device 120. A second user also orders another instance of item 170 online, by use of second computing device 130. The second user orders the second instance of item 170 subsequent to the initiation of en-route delivery of the first instance of item 170 ordered by the first user. The packaging of item 170 includes a tokenized identifier that can be scanned such as by a bar code reader or a QR code reader or another coding on a surface of the packaging. Alternatively, the tokenized identifier may use radio frequency identification (RFID) that can be read by the appropriate RFID reader. The tokenized identifier identifies a link that can be adjusted to indicate a delivery location of item 170 and can be changed by programming the link to a second delivery location during en-route delivery of item 170.

AI information repository 180 stores information regarding the activities, behaviors, and decision making by users of first computing device 120 and second computing device 130 as a corpus of information and data associated with incentives and expedited delivery compensation negotiations and decisions. AI information repository 180 stores the information received from respective users’ computing devices during receipt of incentive offers and back-and-forth activities leading to a decision of agreement or decline. Similarly, AI information repository 180 stores the information received during requests for expedited delivery associated with an online order, and the selection of options of expedited delivery timing and compensation required, as well as declining all options. AI information repository 180 provides training data for machine learning applications installed on first computing device 120 and second computing device 130 to develop a virtual persona enabled to receive incentive input or expedited delivery timing and compensation required and make decisions based on a respective user’s related offer, counteroffer, and decision history. In some embodiments, the machine learning training may include supervised learning by input from the respective user of the computing device.

In some embodiments of the present invention, expedite delivery program 200 receives online requests for expedited delivery of one or more ordered items and determines whether instances of the same item ordered are already en-route for delivery. Expedite delivery program 200 communicates offers of incentives for delayed delivery of the en-route ordered items and options of delivery timeframes and compensation for the expedited delivery. In response to receiving agreement to incentives and required compensation, expedite delivery program 200 sends rerouting information to shipping computing device 140, changing the delivery destination to a location corresponding to the user requesting expedited delivery of the ordered item via the user’s computing device, such as second computing device 130. The change of delivery destination is made to the data linked to the tokenized identifier on the packaging of the item while the item is en-route.

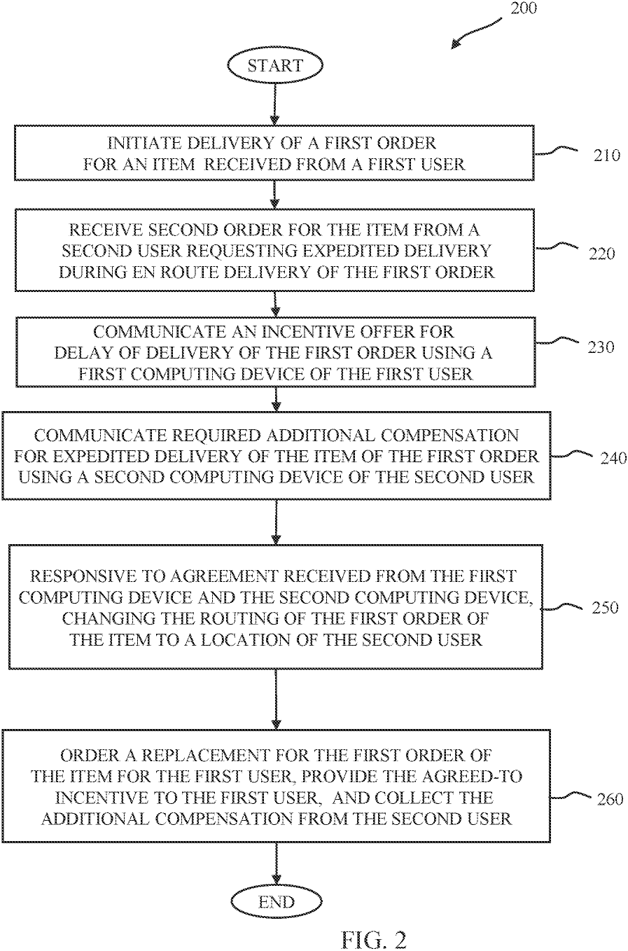

FIG. 2 depicts a flowchart of the operational steps of expedite delivery program 200, in accordance with an embodiment of the present invention. Expedite delivery program 200 initiates delivery of a first order for an item received from a first user (step 210). Expedite delivery program 200 receives an online order for an item placed from a first computing device of a first user. Expedite delivery program 200 processes the order and packages and prepares the item for delivery transport. Expedite delivery program 200 determines an en-route status of the delivery of the item to the destination location provided in the online order. In embodiments of the present invention, expedite delivery program 200 provides a link from a tokenized identifier on the packaging of the item to the delivery location address. In some embodiments, the tokenized identifier can be read or scanned to determine the link from which the delivery location access can be obtained. The tokenized identifier can be a QR code, a barcode, an RFID, or other identifier devices that can identify a link to access a delivery address.

For example, a first user places a first online order for item 170 using first computing device 120. Expedite delivery program 200 receives the information regarding the first online order and initiates delivery of the item to a delivery location address associated with the first user. Expedite delivery program 200 inputs the delivery location address of the first user into a link accessible by reading a tokenized identifier on the packaging for the first order en-route to the delivery location address of the first user.

Expedite delivery program 200 receives a second order for the same item from a second user requesting expedited delivery during en-route delivery of the first order (step 220). A second user places a second online order for the same item ordered by the first user, and requests expedited delivery. The requested expedited delivery includes delivery sooner than typical delivery offerings by providers. As an example, expedited delivery requested by the second user may be in a range of hours as opposed to two or more days. Expedite delivery program 200 receives information regarding the second online order and the request for expedited delivery during en-route delivery of the first online order to the first user.

For example, a second user places a second online order for item 170, an item also ordered by the first user, and the second user requests expedited delivery of item 170. The second user places the order and requests for expedited delivery using second computing device 130. Item 170 currently has an en-route status of delivery to the location address of the first user.

Expedite delivery program 200 communicates an incentive offer for a delay of the delivery of the first order to the first computing device of the first user (step 230). Expedite delivery program 200 determines the delivery locations associated with one or more instances of the ordered item that are en-route to their respective destinations. Expedite delivery program 200 determines whether an instance of the ordered item en-route for delivery can be rerouted to the second user’s delivery location, such that an expedited delivery can be offered. Determining that one or more instances of an en-route delivery of the item can be rerouted to the second user requesting expedited delivery, expedite delivery program 200 generates and communicates an incentive offer in exchange for a delay of the delivery of the en-route item so that the item may be rerouted to fulfill the expedited delivery request. Expedite delivery program 200 communicates an incentive offer to the first computing device associated with the first user that placed the first order for the item. In some embodiments, expedite delivery program 200 communicates an incentive offer to multiple computing devices associated with en-route delivery of an instance of the item, respectively, that can be considered for rerouting to fulfill the request or expedited delivery of the item by the second user. In some embodiments, expedite delivery program 200 may exchange multiple incentive offers with the computing device of the first user to obtain an acceptable agreement for delayed delivery of the item already en-route.

For example, expedite delivery program 200 determines whether the first order for item 170 received from first computing device 120 and already en-route to a delivery location associated with the first user, can be rerouted to the delivery location of the second user to provide the requested expedited delivery. Confirming that item 170 en-route to the first user can be rerouted to the delivery location of the second user and provide expedited delivery, expedite delivery program 200 communicates an incentive offer to first computing device 120 of the first user exchanging an incentive for the first user for delayed delivery of item 170. In some embodiments, the incentive offer includes consideration of the additional compensation that will be required for the expedited delivery request, additional shipping costs, and incentive to the provider of the ordered item, as well as being attractive to the first user associated with first computing device 120.

In some embodiments, the first user associated with first computing device 120 may manually receive, negotiate, and respond to incentives offered by expedite delivery program 200. In other embodiments, subsequent to machine learning (ML) by an application on first computing device 120 utilizing historic transactions by the first user, supervised and unsupervised learning, and/or neural network techniques, first computing device 120 engages a “virtual persona” representing the first user and responds to the incentives offered by expedited delivery in exchange for a delay in delivery of item 170. In some embodiments, the virtual persona associated with first computing device 120 accepts or declines incentives based on machine learning without intervention by the first user.

The activities associated with receipt of incentive offers for the delivery delay and expedited delivery for additional compensation as well as counteroffers, decisions, and associated behaviors can be considered string or alpha-numeric categorical data and, as such, requires conversion to numerical values for use by machine learning. Nominal data types are coded into a variable established for levels of categorical features and may have a binary designation for absence (0) of a feature and presence (1) of the feature. The encoding of data precedes machine learning model development. Embodiments of the present invention may include ordered items as a categorical feature, as well as a quantified incentive offer and estimated delay in delivery. Similarly, expedited delivery options may include categorical variables of delivery estimations and quantified compensation in exchange. Embodiments encode the data as numerical features and input the numerical features into the machine learning model during development stage for classifying the attributes of delivery, incentives, and compensation, as well as consideration of costs and profits for the providing entity.

Embodiments maintain reinforcement machine learning techniques in the virtual personal model, which continuously learns from feedback training to further refine the output of the machine learning model if a generated outcome of incentive or additional compensation, results in unaccepted outcomes. In some embodiments, the ML model for virtual personas applies a rigidity factor determining back-and-forth offers, counteroffers, and decisions made. The rigidity factor applies a confidence level of the output resulting in an action taken. In some embodiments, reinforcement learning includes a reward function parameter, which serves to retrain the ML model, based on correct actions and incorrect actions associated with incentive/compensation activities. Embodiments refine the ML model through time and enable virtual personas associated with first computing device 120 and second computing device 130 to receive, negotiate, and make decisions autonomously on incentive offers and additional compensation options related to delayed and expedited delivery, respectively.

In some embodiments, expedite delivery program 200 analyzes the current location of the first order of item 170 en-route to the first user, the delivery locations of the first user and second user, and determines costs associated with transportation for a change of delivery destination, administrative costs, and reordering costs to replace the first order of item 170 for the first user. Additionally, expedite delivery program 200 considers current demand and availability of item 170 and includes incentive payment for the provider of item 170 offering expedited delivery options. Based on the determined costs, demand, availability, and provider incentive expedite delivery program 200 determines an incentive offer to communicate to the first computing device 120 associated with the first user.

Expedite delivery program 200 communicates required additional compensation for expedited delivery of the item of the first order using a second computing device of the second user (step 240). Having determined at least one instance of the first ordered item en-route for delivery that can be rerouted to the second user requesting expedited delivery and analyzing and determining costs and desired incentive for the provider of the item, expedite delivery program 200 communicates a required additional compensation for the expedited delivery of the item to the computing device of the second user. In some embodiments in which multiple instances exist of the item en-route for delivery and available for rerouting for the requested expedited delivery, expedite delivery program 200 communicates options to the computing device of the second user offering variable expedited delivery timeframes in exchange for varying additional compensation.

For example, expedite delivery program 200 has determined the availability of the first order of item 170 and 2 additional instances of item 170 agreeing to delayed delivery for an incentive offer. Expedite delivery program 200 determines an additional amount of compensation for each instance of item 170 en-route and communicates options to second computing device 130 that include three differing expedited delivery timeframes, each in exchange for varying amounts of additional compensation. Expedite delivery program 200 requests a selection of one of the options or a decline as a response. In some embodiments, only one option may be communicated to second computing device 130. In other embodiments, a back-and-forth negotiation may briefly occur between second computing device 130 and expedite delivery program 200. In an example embodiment, multiple instances of item 170 at various stages of en-route delivery may provide options for expedited delivery, such as a “4 hour, 12 hour, tomorrow, or two-day delivery option.

In some embodiments, the second user associated with second computing device 130 may manually receive, negotiate, and respond to expedite delivery program 200. In other embodiments, subsequent to machine learning by an application on second computing device 130 utilizing historic transactions by the second user, supervised and unsupervised learning, and/or neural network techniques, second computing device 130 engages a “virtual persona” representing the second user and responding to the one or more options of expedited delivery in exchange for additional compensation. In some embodiments, the virtual persona associated with second computing device 130 accepts or declines expedited delivery options based on the machine learning without intervention by the second user.

In some embodiments of the present invention, expedite delivery program 200 determines an opportunity window in which the expedited delivery offer remains available, based on the location of the en-route item and the delivery location of the user requesting the expedited delivery. Expedite delivery program 200 determines a threshold timeframe for acceptance of expedited delivery of the en-route item by the requesting user and communicates the threshold to the second computing device of the second user. In some embodiments, expedite delivery program 200 may withdraw the expedited delivery offer subsequent to the expiration of the threshold timeframe for acceptance by the requesting user.

Responsive to agreement received from the first computing device and the second computing device, expedite delivery program 200 changes the routing of the first order for the item to a delivery location associated with the second user of the second computing device (step 250). Expedite delivery program 200 receives responses from inentive offers communicated to the computing device of the first user and expedited delivery options and required compensation communicated to the second user. In response to receiving an agreement from respective computing devices of the first user and the second user, expedite delivery program initiates rerouting of the first ordered item from delivery to the first user to a delivery location of the second user. Expedite delivery program 200 instructs a shipping vendor associated with the first ordered item en-route to the first user delivery location to change the delivery location to that of the second user. In some embodiments, expedite delivery program 200 instructs the shipping vendor to change the delivery location address associated with the tokenized identifier on the packaging of the ordered item to the delivery location address of the second user.

For example, expedite delivery program sends the delivery location address of the second user and instruction to shipping computing device 140 to change the current delivery location address associated with the tokenized identifier on the packaging for item 170, en-route via delivery transport 160, to the delivery location address of the second user.

Expedite delivery program 200 orders a replacement for the first order of the item for the first user, provides the agreed-to incentive to the first user and collects the additional compensation from the second user (step 260). Expedite delivery program 200 places a re-order for the item, which replaces the original order for the first user that has been rerouted to the second user for expedited delivery, based on agreements reached with the first user for an incentive and the second user for additional compensation. Expedite delivery program 200 performs activity to provide the incentive to the first user, such as an incentive in exchange for the delay of the delivery of the ordered first item and collects or receives confirmation of receipt of the additional compensation from the second user, in exchange for the expedited delivery.

For example, expedite delivery program 200 places a re-order of item 170 with the provider of item 170 via provider computing device 110, and initiates activity to provide the agreed-to incentives or confirmation of providing incentives to first computing device 120. Expedite delivery program 200 also communicates to second computing device 130 an exchange of additional compensation for the expedited delivery and confirms the receipt of the additional compensation. In some embodiments, the act of rerouting item 170, originally ordered by the first user and en-route to the first user, to the delivery location of the second user occurs subsequent to agreements by both parties and the confirmation of receipt of the additional compensation from second computing device 130 of the second user.

In some embodiments, if second computing device 130 of the second user communicates a cancelation of the request for expedited delivery subsequent to the agreement to the additional compensation, expedite delivery program 200 maintains the additional compensation as a penalty and reroutes the delivery of item 170 to the original delivery location of the first user by notifying shipping computing device 140 to change the link to the tokenized identifier on the packaging of item 170 and notify delivery transport 160 of the changes.

In some embodiments, expedite delivery program 200 determines ordered items that are in high demand and communicates with provider-vendors to package the high-demand item separately from other items that may be ordered at the same time (i.e., multi-item orders) and are typically packaged together in one delivery package. Separation of the high-demand item provides an opportunity for offering expedited delivery by rerouting the high-demand item en-route.

In some embodiments, expedite delivery program 200 may indicate the possibility of receipt of incentives in exchange for an agreement to a delayed delivery as the first user makes the initial online order for the item. Agreement by the first user via first computing device 120 enables expedite delivery program 200 greater opportunity to offer expedited delivery for the item to subsequent orders at the time of order, based on the indicated delivery location of the user placing the order. For example, a first user places an online order of item 170 and before making payment, expedite delivery program 200 presents the potential of offering an incentive for agreement by the user to delayed delivery of the ordered item. Similarly, before the conclusion of a second online order by a second user subsequent to the agreement by the first user to delayed delivery, expedite delivery program 200 may indicate to the second user that options for expedited delivery are available. In some embodiments, a trained virtual persona operating on respective computing devices of a first user and a second user may detect the availability of incentives for delayed delivery and availability of expedited delivery in exchange for additional compensation. In some embodiments, the respective virtual personas make decisions to accept or decline for their respective user counterparts as an AI application, based on machine learning training from historical transactions of respective users and manual input.

In some embodiments, the delivery planning of the initial order of the item may include an adjustment allowing for time to offer an opportunity for expedited delivery and recovery of additional compensation and may package and ship items with a high likelihood of expedited delivery requests separately if ordered as part of a multi-item order.

FIG. 3 depicts a block diagram of components of computing system 300, including computing device 305, configured to include or operationally connect to components depicted in FIG. 1, and with the capability to operationally perform expedite delivery program 200 of FIG. 2, in accordance with an embodiment of the present invention.

Computing device 305 includes components and functional capability similar to components of computing device 110 (FIG. 1), in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 305 includes communications fabric 302, which provides communications between computer processor(s) 304, memory 306, persistent storage 308, communications unit 310, an input/output (I/O) interface(s) 312. Communications fabric 302 can be implemented with any architecture designed for passing data and/or control information between processors (such as microprocessors, communications, network processors, etc.), system memory, peripheral devices, and any other hardware components within a system. For example, communications fabric 302 can be implemented with one or more buses.

Memory 306, cache memory 316, and persistent storage 308 are computer-readable storage media. In this embodiment, memory 306 includes random access memory (RAM) 314. In general, memory 306 can include any suitable volatile or non-volatile computer-readable storage media.

In one embodiment, persistent storage 308 stores expedite delivery program 200 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid-state hard drive, a semiconductor storage device, read-only memory (ROM), erasable programmable read-only memory (EPROM), flash memory, or any other computer-readable storage media with the capability of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium as part of persistent storage 308.

Communications unit 310, in these examples, provides for communications with other data processing systems or devices, including resources of distributed computer processing environment 100. In these examples, communications unit 310 includes one or more network interface cards. Communications unit 310 may provide communications through the use of either or both physical and wireless communications links. Expedite delivery program 200 may be downloaded to persistent storage 308 through communications unit 310.

I/O interface(s) 312 allows for input and output of data with other devices that may be connected to computing system 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., expedite delivery program 200 can be stored on such portable computer-readable storage media and can be loaded onto persistent storage 308 via I/O interface(s) 312. I/O interface(s) 312 also connects to a display 320.

Display 320 provides a mechanism to display data to a user and may, for example, be a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer, and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for dynamic enablement of delivery re-allocation en-route, based on incentive negotiation, the method comprising:
one or more processors receiving an online order for an item from a first user;
the one or more processors linking a first delivery location of the first user to a tokenized identifier attached to a package including the item and initiating delivery of the item to the first delivery location of the first user;
the one or more processors receiving a second order for the item from a second user while the item ordered by the first user is en-route for delivery to the first user, wherein the second user requests expedited delivery of the item;
the one or more processors offering a first incentive to a first computing device of the first user, wherein the first incentive is in exchange for a delayed delivery of the item ordered by the first user;
the one or more processors offering an expedited delivery timeframe in exchange for additional compensation to a second computing device of the second user; and
in response to receiving an acceptance of the incentive from the first computing device and an acceptance of the expedited delivery in exchange for additional compensation from the second computing device, the one or more processors changing the link to the tokenized identifier to a second delivery location of the second user while the package including the item is en-route.

2. The method of claim 1, further comprising:
the one or more processors determining a threshold of time for confirmation of negotiated offers while the item is en-route to delivery to the first user, based on a location of the item and a distance to the first delivery location of the first user and the second delivery location of the second user.

3. The method of claim 1, wherein a decision is received from the first computing device regarding an acceptance of the incentive and from the second computing device regarding the expedited delivery timeframe and the additional compensation prior to an expiration of a threshold time corresponding to the proximity of delivery of the item to the first delivery location of the first user.

4. The method of claim 1 wherein the tokenized identifier is a scannable object attached to the package including the item for delivery.

5. The method of claim 1, wherein changing the link of the tokenized identifier to the second delivery location of the second user further comprises:
the one or more processors confirming provision of the first incentive to the first computing device;
the one or more processors confirming receipt of the additional compensation from the second computing device; and
the one or more processors initiating processing of a new delivery of another instance of the item to the first user.

6. The method of claim 1, wherein the response to the incentive offered to the first computing device and the expedited delivery for the additional compensation offered to the second computing device are received automatically from respective virtual personas of the first user and the second user.

7. The method of claim 1, further comprising:
the one or more processors negotiating the incentive for delayed delivery of the item with the first computing device of the first user; and
the one or more processors negotiating the expedited delivery timeframe and the additional compensation with the second computing device of the second user.

8. A method for a set of virtual personas for item delivery decisions, the method comprising:
one or more processors monitoring received information and responses associated with offers of incentives for delayed delivery of an online ordered item and offers of expedited delivery in exchange for additional compensation;
the one or more processors storing historic data of the received information and the responses of incentives and the received information and the responses associated with the expedited delivery of an online ordered item as a corpus of delivery transaction data in a repository;
the one or more processors applying machine learning techniques to the delivery transaction data from the repository, wherein the machine learning techniques include unsupervised machine learning, supervised machine learning, and manual input of limitations and circumstances;
the one or more processors generating a first virtual persona of a first user operating a first computing device to receive an offer of an incentive in exchange for the delayed delivery of an ordered item, wherein the first virtual persona performs counter offers and a decision to accept or decline an ultimate incentive, based on the machine learning; and
the one or more processors generating a second virtual persona of a second user operating a second computing device to receive an offer of one or more expedited delivery options in exchange for a quantified additional compensation, wherein the second virtual persona performs counter offers and a decision to accept or decline an ultimate additional compensation in exchange for a designated expedited delivery of the item, based on the machine learning.

9. The method of claim 8, wherein the first virtual persona and the second virtual persona improve decision performance by receiving feedback on decisions made.

10. The method of claim 8, wherein the first user and the second user manually set overriding parameters for respective virtual personas for decisions regarding incentives for delayed delivery and compensation for expedited delivery.

11. The method of claim 8, wherein the machine learning techniques used to train the first virtual persona and the second virtual persona include applying a rigidity factor determining a confidence level of an output decision, based on historic offers, counteroffers, and decisions made.

12. The method of claim 8, wherein the machine learning techniques include reinforcement learning applying a reward function parameter serving to retrain a machine learning model, based on correct actions and incorrect actions associated with incentives and compensation decisions.

13. The method of claim 8, wherein the first virtual persona of the first user operating the first computing device and the second virtual persona of the second user operating the second computing device make decisions to accept or decline, based on machine learning training from historical transactions of respective users and manual input.

14. A computer system for dynamic enablement of delivery re-allocation en-route, based on incentive negotiation, the computer system comprising:
one or more computer processors;
one or more computer-readable storage media, and program instructions stored on the one or more computer-readable storage media, the program instructions comprising:
program instructions to receive an online order for an item from a first user;
program instructions to link a first delivery location of the first user to a tokenized identifier attached to a package including the item and initiating delivery of the item to the first delivery location of the first user;
program instructions to receive a second order for the item from a second user while the item ordered by the first user is en-route for delivery to the first user, wherein the second user requests expedited delivery of the item;
program instructions to offer a first incentive to a first computing device of the first user, wherein the first incentive is in exchange for a delayed delivery of the item ordered by the first user;
program instructions to offer an expedited delivery timeframe in exchange for additional compensation to a second computing device of the second user; and
in response to receiving an acceptance of the incentive from the first computing device and an acceptance of the expedited delivery in exchange for additional compensation from the second computing device, program instructions to change the link to the tokenized identifier to a second delivery location of the second user while the package including the item is en-route.

15. The computer system of claim 14, further comprising:
program instructions to determine a threshold time of confirming negotiation while the item is en-route to delivery to the first user, based on a location of the item and a distance to the first delivery location of the first user and the second delivery location of the second user.

16. The computer system of claim 14, wherein program instructions to receive a decision from the first computing device regarding acceptance of the incentive and from the second computing device regarding the expedited delivery timeframe and the additional compensation, prior to expiration of a threshold time corresponding to the proximity of delivery of the item to the first delivery location of the first user.

17. The computer system of claim 14, wherein the tokenized identifier is a scannable object attached to the package including the item for delivery.

18. The computer system of claim 14, wherein changing the link to the tokenized identifier to the second delivery location of the second user further comprises:
program instructions to confirm provision of the first incentive to the first computing device;
program instructions to confirm receipt of the additional compensation from the second computing device; and
program instructions to initiate processing of a new delivery of another instance of the item to the first user.

19. The computer system of claim 14, wherein program instructions include receiving the response to the incentive offered to the first computing device and the expedited delivery for the additional compensation offered to the second computing device are received automatically from respective virtual personas of the first user and the second user.

20. The computer system of claim 14, further comprising:
program instructions to determine an acceptable incentive for delayed delivery of the item with the first computing device of the first user; and
program instructions to determine an acceptable offer for the expedited delivery timeframe and the additional compensation with the second computing device of the second user.
